(19) United States
(12) Patent Application Publication
(10) Pub. No.: US 2026/0116291 A1
(43) Pub. Date: Apr. 30, 2026

(54) DRIVER MONITORING APPARATUS AND METHOD

(71) Applicants: HON HAI PRECISION INDUSTRY CO., LTD., New Taipei City (TW); Foxconn Technology Group Co., Ltd., Guangdong Province (CN)

(72) Inventors: San Sheng SHEN, New Taipei City (TW); Hao Syuan CHANG, New Taipei City (TW)

(21) Appl. No.: 19/052,247

(22) Filed: Feb. 12, 2025

(30) Foreign Application Priority Data
Oct. 25, 2024 (TW) 113140911

(51) Int. Cl. B60Q 9/00; G01B 11/22; G01S 17/42

(52) U.S. Cl. CPC B60Q 9/00; G01B 11/22; G01S 17/42

(57) ABSTRACT

A driver monitoring apparatus and method are provided. The apparatus emits light toward a driver. The apparatus receives the light reflected by the driver to generate reflected light data. The apparatus calculates real-time depth data of the driver based on the reflected light data. The apparatus compares the real-time depth data and standard depth data to calculate a depth difference. The apparatus determines whether to execute a warning operation based on the depth difference.

### CROSS-REFERENCE TO RELATED APPLICATION

This application claims priority to Taiwan Application Serial Number 113140911, filed Oct. 25, 2024, which is herein incorporated by reference in its entirety.

### BACKGROUND

### Field of Invention

The present disclosure relates to driver monitoring apparatus and method. More particularly, the present disclosure relates to driver monitoring apparatus and method based on time-of-flight (ToF) measurement.

### Description of Related Art

With the development of assisted driving technology, driver monitoring technology can be used to confirm whether the driver is focused on the surrounding environment and has the ability to control the vehicle. Specifically, a driver monitoring system can be installed on the vehicle and confirm whether the driver is distracted for other behaviors (e.g., talking on the phone, eating) by cameras, sensors, and/or other technical means.

Existing technologies mostly use image recognition models to confirm driver behavior. However, while training a machine learning model, it is necessary to provide images in various situations as training data so that the model can learn to identify the situations. In contrast, the trained model can only classify situations that have appeared in the training data, but not able to deal with unexpected situations.

In view of this, how to provide a more versatile driver monitoring technology is the goal that the industry strives to work on.

### SUMMARY

The disclosure provides a driver monitoring apparatus comprising an emitting unit, a light sensor, and a processor. The emitting unit is configured to emit first light toward a driver. The light sensor is configured to receive the first light reflected by the driver to generate first reflected light data. The processor is coupled to the emitting unit and the light sensor and configured to execute the following operations: calculating real-time depth data of the driver based on the first reflected light data; comparing the real-time depth data and standard depth data to calculate a depth difference; and determining whether to execute a warning operation based on the depth difference.

The disclosure further provides a driver monitoring method, being adapted for use in an electronic apparatus, wherein the driver monitoring method comprises the following steps: emitting first light toward a driver; receiving the first light reflected by the driver to generate first reflected light data; calculating real-time depth data of the driver based on the first reflected light data; comparing the real-time depth data and standard depth data to calculate a depth difference; and determining whether to execute a warning operation based on the depth difference.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a driver monitoring apparatus according to a first embodiment of the present disclosure.

FIG. 2 is a flow diagram illustrating the driver monitoring apparatus detecting the driver according to some embodiments of the present disclosure.

FIG. 3 is a schematic diagram illustrating the driver monitoring apparatus calculating the depth difference through iterative operations difference according to some embodiments of the present disclosure.

FIG. 4 is a flow diagram illustrating a driver monitoring method according to a second embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

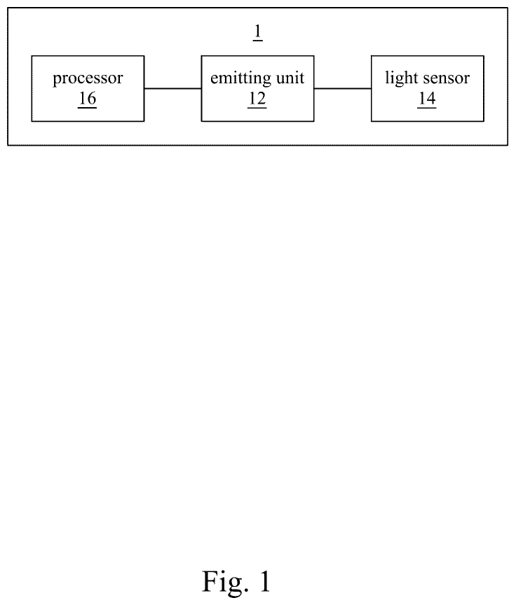

Please refer to FIG. 1, which is a schematic diagram illustrating a driver monitoring apparatus according to a first embodiment of the present disclosure. The driver monitoring apparatus 1 comprises a processor 12, an emitting unit 14, and a light sensor 16, wherein the processor 12 is electrically connected to the emitting unit 14 and the light sensor 16 relatively. The driver monitoring apparatus 1 is configured to detect whether a driver behaves abnormally and take corresponding measures.

In some embodiments, the processor 12 comprises a central processing unit (CPU), a graphics processing unit (GPU), a multi-processor, a distributed processing system, an application specific integrated circuit (ASIC), and/or a suitable processing unit.

The emitting unit 14 is configured to emit light to the driver for the light sensor 16 to receive the reflected light, and the light sensor 16 is configured to generate reflected light data based on the characteristics of the reflected light. For example, the reflected light data comprises travel time of the reflected light from being emitted by the emitting unit 14 to being received by the light sensor 16, reflected angle of reflected light, and/or other characteristics. Accordingly, the driver monitoring apparatus 1 is able to calculate the depth information of the driver based on the reflected light data by using time-of-flight measurement.

In some embodiments, the emitting unit 14 comprises an infrared light-emitting diode (IR LED), and the light sensor 16 comprises an infrared sensor correspondingly. Since there is little infrared light in the natural environment, the light sensor 16 will not be interfered by other light sources and have the driver monitoring apparatus 1 to calculate more accuracy driver depth information.

In some embodiments, the emitting unit 14 is configured in the vehicle and configured to emit light toward the face area of the driver's seat (e.g., the area around the headrest of the driver's seat), and then the light sensor 16 is configured to receive light from the face area of the driver's seat correspondingly. Accordingly, the driver monitoring apparatus 1 is able to detect the driver's face.

After receiving the reflected light form the driver, the driver monitoring apparatus 1 calculates the real-time depth data of the driver accordingly, wherein the real-time depth data indicates the undulations of the driver's exterior surface.

Next, the driver monitoring apparatus 1 compares the real-time depth data and standard depth data and calculate the difference between the real-time depth data and the standard depth data, wherein the standard depth data is the driver depth data (e.g., a point cloud composed of multiple three-dimensional coordinates) measured when the driver is in a standard driving posture. If the difference between the real-time depth data and the standard depth data exceeds a certain amount, it is indicated that the driver may be distracted due to irregular behaviors, and the driver monitoring apparatus 1 will take the corresponding measure (e.g., controlling the speaker to make sound, controlling the screen to display notice, increasing the level of driving assistance involvement, etc.) to reduce the driving risk.

For example, while the driver is eating, talking on the phone or smoking, the driver's hands may come off the steering wheel and closer to their face, and food, phone, cigarette, or other object will appear around their face. Accordingly, the real-time depth data detected by the driver monitoring apparatus 1 will have a considerable depth difference form the standard depth data, and the driver monitoring apparatus 1 can take the corresponding measurement accordingly.

Specifically, the processor 12 is configured to execute the following operations: calculating real-time depth data of the driver based on the first reflected light data; comparing the real-time depth data and standard depth data to calculate a depth difference; and determining whether to execute a warning operation based on the depth difference.

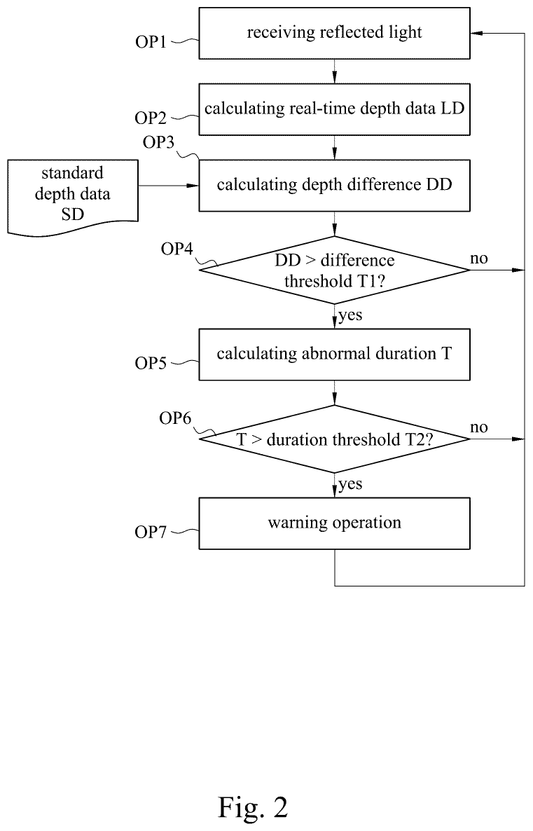

About the operation details of the driver monitoring apparatus 1, please refer to FIG. 2, which is a flow diagram illustrating the driver monitoring apparatus 1 detecting the driver according to some embodiments of the present disclosure.

First, in operation OP1, the driver monitoring apparatus 1 receives the light reflected from the driver and generates reflected light data.

Next, in operation OP2, the driver monitoring apparatus 1 calculates real-time depth data LD of the driver based on the reflected light data.

In some embodiments, the driver monitoring apparatus 1 transforms the reflected light data into multiple three-dimensional coordinates, the three-dimensional coordinates are configured to represent the positions of the driver's exterior surface in a three-dimensional space and can be used to construct the point cloud of the three-dimensional appearance of the driver.

Specifically, the operation of the processor 12 calculating the real-time depth data further comprises: transforming the first reflected light data to a plurality of first three-dimensional coordinates by using a time-of-flight measurement; and taking the first three-dimensional coordinates as the real-time depth data.

In some embodiments, the driver monitoring apparatus 1 calculates three-dimensional coordinates corresponding to the driver based on the reflected distance and reflected angle of the light received by the light sensor 16.

Specifically, the operation of the processor 12 transforming the first reflected light data to the first three-dimensional coordinates further comprises: calculating the first three-dimensional coordinates based on a plurality of reflecting distances, a plurality of first reflecting angles, and a plurality of second reflecting angles.

For example, when the driver monitoring apparatus 1 calculates the three-dimensional coordinates based on time-of-flight measurement, the reflected light data generated by the light sensor 16 comprises distance r, rotation angle θ around z-axis, and z-axis downward rotation angle φ. Accordingly, the processor 12 is able to transform the distance and angles into a three-dimensional coordinate (x, y, z) based on the following formula 1.

$$( x , y , z ) , \{ \begin{matrix}x = r sin ( ϕ ) cos ( θ ) \\ y = r sin ( ϕ ) sin ( ϕ ) \\ z = r cos ( ϕ )\end{matrix} , \qquad ( formula 1 )$$

Next, in operation OP3, the driver monitoring apparatus 1 compares the real-time depth data LD and a standard depth data SD to calculate a depth difference DD. The standard depth data SD is the depth data measured when the driver is in a standard driving posture. Correspondingly, the depth difference DD is configured to represent the difference between the current posture of the driver and the standard driving posture.

Specifically, the processor 12 calculates the differences between multiple coordinates in the real-time depth data LD and the standard depth data SD to calculate the depth difference DD.

Since the driver moves constantly, and the standard depth data SD may not be perfectly fitted to the real-time depth data LD to compare directly. Therefore, in some embodiments, the driver monitoring apparatus 1 first matches the standard depth data SD to the position of the real-time depth data LD by rotating and/or translating the standard depth data SD, and then calculating the depth difference DD between them.

Specifically, the operation of the processor 12 calculating the depth difference further comprises: matching the standard depth data to the real-time depth data based on a plurality of first three-dimensional coordinates of the real-time depth data; and calculating a difference between the real-time depth data and the matched standard depth data as the depth difference.

In some embodiments, the driver monitoring apparatus 1 calculates the depth difference DD through multiple iterative operations based on Iterative Closest Point (ICP) algorithm.

Specifically, the operation of the processor 12 calculating the depth difference further comprises a plurality of iterative operations, wherein each of the iterative operations comprises the following operations: selecting one of a plurality of first three-dimensional coordinates of the real-time depth data as a corresponding point based on each of a plurality of second three-dimensional coordinates of the standard depth data; calculating a transformation matrix based on the second three-dimensional coordinates and the corresponding point corresponding to each of the second three-dimensional coordinates; transforming the second three-dimensional coordinates based on the transformation matrix; and calculating a root-mean-square error based on the transformed second three-dimensional coordinates and the first three-dimensional coordinates.

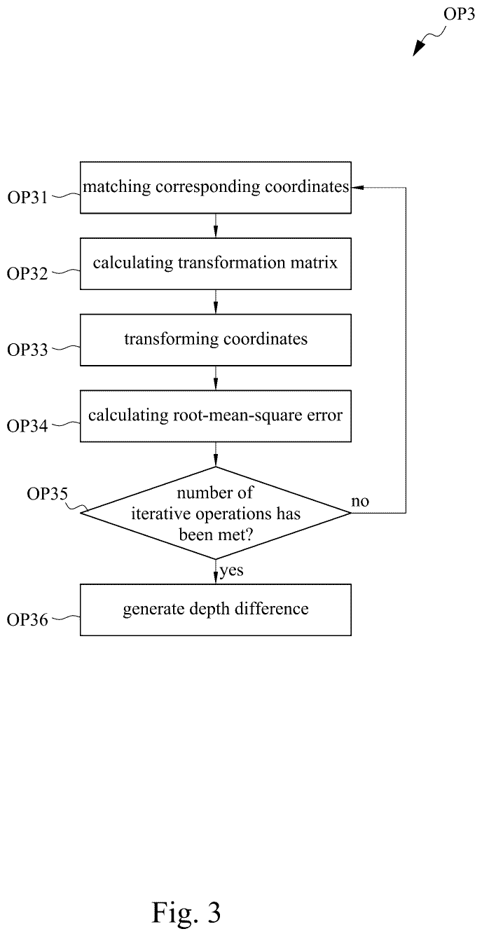

About the detail operations of calculating the depth difference DD, please refer to FIG. 3, which is a schematic diagram illustrating the driver monitoring apparatus 1 calculating the depth difference DD through iterative operations difference according to some embodiments of the present disclosure. As shown in the figure, the operation OP3 further comprises operations OP31-OP36, wherein each round of the iterative operations consists of the operations OP31-OP35.

First, in the operation OP31, the driver monitoring apparatus 1 matches multiple coordinates of the standard depth data SD to the corresponding coordinates among multiple coordinates of the real-time depth data LD.

For example, the processor 12 searches the nearest corresponding coordinate of each of the coordinates of the standard depth data SD from the coordinates of the real-time depth data LD by using Nearest Neighbor Search (NNS) algorithm.

Next, in the operation OP32, the driver monitoring apparatus 1 calculates a transformation matrix based on the relationships between the coordinates of the standard depth data SD and the corresponding coordinates, wherein the transformation matrix is configured to rotate and/or translate the coordinates of the standard depth data SD to the corresponding coordinates and match the standard depth data SD to the real-time depth data LD.

For example, the processor 12 calculates the transformation matrix matching the standard depth data SD to the real-time depth data LD by using least squares method.

Next, in the operation OP33, the driver monitoring apparatus 1 transforms the coordinates of the standard depth data SD by the transformation matrix. Namely, the driver monitoring apparatus 1 rotates and/or translates the standard depth data SD to the position of the real-time depth data LD based on the transformation matrix.

Next, in the operation OP34, the driver monitoring apparatus 1 calculates the root-mean-square error (RMSE) between the coordinates of the matched standard depth data SD and the real-time depth data LD.

Next, in the operation OP35, the driver monitoring apparatus 1 determines whether the number of the iterative operations has been met.

In some embodiments, the driver monitoring apparatus 1 determines whether the number of the iterative operations executed has exceeds a times threshold (e.g., 10 times).

Specifically, the operation of the processor 12 calculating the depth difference further comprises: in response to performing the iterative operations reaching a times threshold, taking the root-mean-square error calculated in the last iterative operation as the depth difference.

Furthermore, if the number of the iterative operations has not been met, the driver monitoring apparatus 1 returns to the operation OP31 and executes a new round of the iterative operation. Relatively, if the number of the iterative operations has been met, the driver monitoring apparatus 1 executes the operation OP36, taking the root-mean-square error calculated in the operation OP34 as the depth difference DD.

It is noted that, when the vehicle first starts, the driver monitoring apparatus 1 prompts the driver to assume the standard driving posture and records the standard depth data SD by the emitting unit 14 and the light sensor 16.

Specifically, the standard depth data is generated by the following operations: emitting second light to the driver and receiving the second light reflected by the driver to generate second reflected light data, wherein the driver is in a standard driving posture; and calculating the standard depth data corresponding to the driver based on the second reflected light data.

It is noticed that, the standard depth data SD may be generated by the driver monitoring apparatus 1 or other apparatuses with similar functions, and the present disclosure is not limited thereto.

In some embodiments, the standard depth data SD is generated by personnel assisting the driver in operating the driver monitoring apparatus 1 when the vehicle is handed over to the driver.

In some embodiments, the driver monitoring apparatus 1 records the depth data of the driver continuously while the vehicle is moving. Accordingly, the driver monitoring apparatus 1 adjusts the standard depth data SD by the depth data recorded after removing the outlier.

Please return to FIG. 2, after calculating the depth difference DD, the driver monitoring apparatus 1 executes operation OP4, determining whether the depth difference DD is greater than a difference threshold T1, wherein the difference threshold T1 can be set referring to the detection range, accuracy, and/or interference level of the driver monitoring apparatus 1.

Since the depth difference DD is configured to indicate the difference between the current posture of the driver and the standard driver posture, if the depth difference DD exceeds a certain level, indicating that the driver may be engaging in other behaviors such as eating, talking on the phone, smoking, etc.

Therefore, if the depth difference DD is greater than the difference threshold T1, the driver monitoring apparatus 1 further executes operation OP5, calculating an abnormal duration T. Relatively, if the depth difference DD is not greater than the difference threshold T1, the driver monitoring apparatus 1 returns to the operation OP1 to detect the driver again.

In the operation OP5, the driver monitoring apparatus 1 detects the driver's posture continuously and times the abnormal duration T until the depth difference DD is not greater than the threshold T1.

Furthermore, the driver monitoring apparatus 1 determines whether the abnormal duration T is greater than a duration threshold T2 continuously in operation OP6. When the abnormal duration T is greater than the duration threshold T2, the driver monitoring apparatus 1 executes operation OP7, executing a warning operation. Relatively, if the driver returns to the standard driving posture (i.e., the depth difference DD not greater than the difference threshold T1) before the abnormal duration T exceeds the duration threshold T2, the driver monitoring apparatus 1 then returns to the operation OP1 to detect the driver again.

Specifically, the operation of the processor 12 determining whether to execute the warning operation further comprises: in response to the depth difference being greater than a difference threshold, calculating an abnormal duration; and in response to the abnormal duration exceeding a duration threshold, executing the warning operation.

In the operation OP7, the driver monitoring apparatus 1 executes the warning operation to warn the driver to maintain the standard driving posture, wherein the specific warning operation may be adjusted referring to the equipment of the vehicle.

In some embodiments, the driver monitoring apparatus 1 generates a control signal to control the equipment of the vehicle to warn the driver. For example, controlling the speaker to make sound, controlling the screen to display notice, etc.

Specifically, the warning operation comprises the processor 12 generating a control signal to make an output apparatus to issue warning.

In some embodiments, the warning operation further comprises the driver monitoring apparatus 1 reducing the driving risk of the vehicle by adjusting the involvement level of the driving assistance functions (e.g., Autonomous Emergency Braking (AEB), Adaptive Cruise Control (ACC), Lane Centering Control (LCC)).

Specifically, the warning operation comprises the processor 12 adjusting a driving assistance parameter to increase a level of driving assistance involvement for a vehicle drove by the driver.

For example, in order to avoid the driver from being distracted and further causing accidents, the driver monitoring apparatus 1 adjusts the driving assistance parameters to increase the driving assistance involvement level. For example, increasing distance from the vehicle in front, reducing driving speed, increasing the decision-making time of the automatic braking system to intervene in braking earlier.

In some embodiments, the warning operation further comprises the driver monitoring apparatus 1 controlling the control system components such as throttle, brake, steering wheel, transmission, so as to intervene the vehicle control directly. For example, reducing the speed and pulling the vehicle to the side of the road to reduce the driving risk of the vehicle.

Specifically, the warning operation comprises the processor 12 generating a control signal to control a control system of a vehicle drove by the driver.

In summary, the driver monitoring apparatus 1 provided by the present disclosure issues warning or increases the involvement level of the vehicle when the driver may commit violation by optical detection method, so as to reduce the driving risk. Since the driver monitoring apparatus 1 detects by emitting lights actively, the interference from the environment can be reduced. Since the emitting unit and the light sensor have simple structures, and it does not require massive resources to train the image recognition model, the cost of the driver monitoring apparatus 1 is low. Additionally, the driver monitoring apparatus 1 is not limited to the known situations and able to detect abnormal behaviors correctly when encountering unexpected situations. Therefore, the driver monitoring apparatus 1 has high versatility.

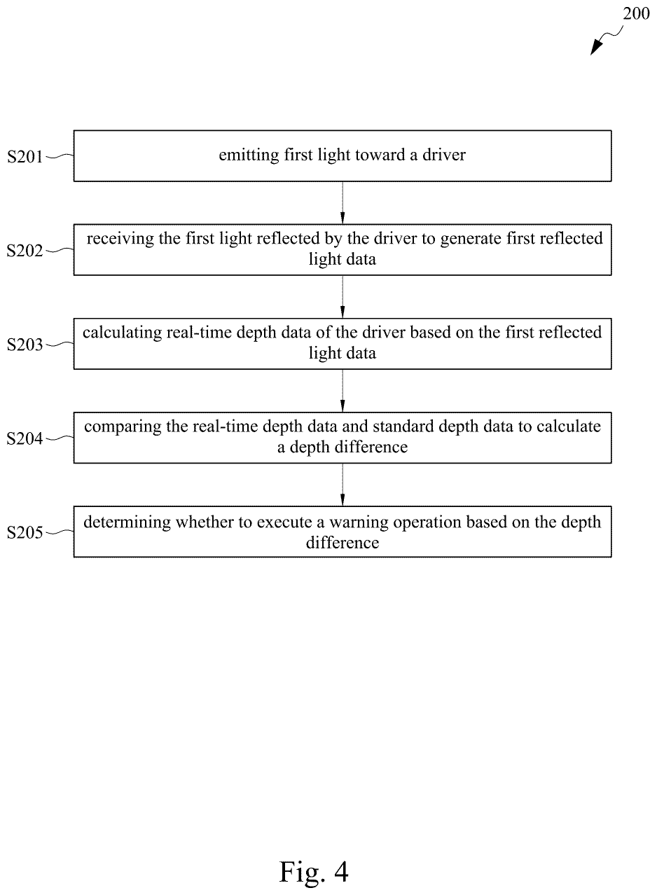

Please refer to FIG. 4, which is a flow diagram illustrating a driver monitoring method 200 according to a second embodiment of the present disclosure. The driver monitoring method 200 comprises steps S201-S205. The driver monitoring method 200 is configured to detect whether a driver behaves abnormally and take corresponding measures. The driver monitoring method 200 can be executed by an electronic apparatus (e.g., the driver monitoring apparatus 1 in the first embodiment).

First, in the step S201, the electronic apparatus emits first light toward a driver.

Next, in the step S202, the electronic apparatus receives the first light reflected by the driver to generate first reflected light data.

Next, in the step S203 the electronic apparatus calculates real-time depth data of the driver based on the first reflected light data.

Next, in the step S204, the electronic apparatus compares the real-time depth data and standard depth data to calculate a depth difference.

Finally, in the step S205, the electronic apparatus determines whether to execute a warning operation based on the depth difference.

In some embodiments, the step S203 further comprises the electronic apparatus transforming the first reflected light data to a plurality of first three-dimensional coordinates by using a time-of-flight calculation; and the electronic apparatus taking the first three-dimensional coordinates as the real-time depth data.

In some embodiments, the step of transforming the first reflected light data to the first three-dimensional coordinates further comprises the electronic apparatus calculating the first three-dimensional coordinates based on a plurality of reflecting distances, a plurality of first reflecting angles, and a plurality of second reflecting angles.

In some embodiments, the step S204 further comprises the electronic apparatus matching the standard depth data to the real-time depth data based on a plurality of first three-dimensional coordinates of the real-time depth data; and the electronic apparatus calculating a difference between the real-time depth data and the matched standard depth data as the depth difference.

In some embodiments, the step S204 further comprises a plurality of iterative operations, wherein each of the iterative operations comprises the following steps: the electronic apparatus selecting one of a plurality of first three-dimensional coordinates of the real-time depth data as a corresponding point based on each of a plurality of second three-dimensional coordinates of the standard depth data; the electronic apparatus calculating a transformation matrix based on the second three-dimensional coordinates and the corresponding point corresponding to each of the second three-dimensional coordinates; the electronic apparatus transforming the second three-dimensional coordinates based on the transformation matrix; and the electronic apparatus calculating a root-mean-square error based on the transformed second three-dimensional coordinates and the first three-dimensional coordinates.

In some embodiments, the step S204 further comprises in response to performing the iterative operations reaching a times threshold, the electronic apparatus taking the root-mean-square error calculated in the last iterative operation as the depth difference.

In some embodiments, the standard depth data is generated by the following steps: emitting second light to the driver and receiving the second light reflected by the driver to generate second reflected light data, wherein the driver is in a standard driving posture; and calculating the standard depth data corresponding to the driver based on the second reflected light data.

In some embodiments, the step S205 further comprises in response to the depth difference being greater than a difference threshold, the electronic apparatus calculating an abnormal duration; and in response to the abnormal duration exceeding a duration threshold, the electronic apparatus executing the warning operation.

In some embodiments, the warning operation comprises the electronic apparatus adjusting a driving assistance parameter to increase a level of driving assistance involvement for a vehicle drove by the driver.

In some embodiments, the warning operation comprises the electronic apparatus generating a control signal to make an output apparatus to issue warning.

In some embodiments, the warning operation comprises the electronic apparatus generating a control signal to control a control system of a vehicle drove by the driver.

In summary, the driver monitoring method 200 provided by the present disclosure issues warning or increases the involvement level of the vehicle when the driver may commit violation by optical detection method, so as to reduce the driving risk. Since the driver monitoring method 200 detects by emitting lights actively, the interference from the environment can be reduced. Since the emitting unit and the light sensor have simple structures, and it does not require massive resources to train the image recognition model, the cost of the driver monitoring method 200 is low. Additionally, the driver monitoring method 200 is not limited to the known situations and able to detect abnormal behaviors correctly when encountering unexpected situations. Therefore, the driver monitoring method 200 has high versatility.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A driver monitoring apparatus, comprising:
an emitting unit, configured to emit first light toward a driver;
a light sensor, configured to receive the first light reflected by the driver to generate first reflected light data; and
a processor, coupled to the emitting unit and the light sensor, configured to execute the following operations:
calculating real-time depth data of the driver based on the first reflected light data;
comparing the real-time depth data and standard depth data to calculate a depth difference; and
determining whether to execute a warning operation based on the depth difference.

2. The driver monitoring apparatus of claim 1, wherein the operation of calculating the real-time depth data further comprises:
transforming the first reflected light data to a plurality of first three-dimensional coordinates by using a time-of-flight measurement; and
taking the first three-dimensional coordinates as the real-time depth data.

3. The driver monitoring apparatus of claim 2, wherein the operation of transforming the first reflected light data to the first three-dimensional coordinates further comprises:
calculating the first three-dimensional coordinates based on a plurality of reflecting distances, a plurality of first reflecting angles, and a plurality of second reflecting angles.

4. The driver monitoring apparatus of claim 1, wherein the operation of calculating the depth difference further comprises:
matching the standard depth data to the real-time depth data based on a plurality of first three-dimensional coordinates of the real-time depth data; and
calculating a difference between the real-time depth data and the matched standard depth data as the depth difference.

5. The driver monitoring apparatus of claim 1, wherein the operation of calculating the depth difference further comprises a plurality of iterative operations, wherein each of the iterative operations comprises the following operations:
selecting one of a plurality of first three-dimensional coordinates of the real-time depth data as a corresponding point based on each of a plurality of second three-dimensional coordinates of the standard depth data;
calculating a transformation matrix based on the second three-dimensional coordinates and the corresponding point corresponding to each of the second three-dimensional coordinates;
transforming the second three-dimensional coordinates based on the transformation matrix; and
calculating a root-mean-square error based on the transformed second three-dimensional coordinates and the first three-dimensional coordinates.

6. The driver monitoring apparatus of claim 5, wherein the operation of calculating the depth difference further comprises:
in response to performing the iterative operations reaching a times threshold, taking the root-mean-square error calculated in the last iterative operation as the depth difference.

7. The driver monitoring apparatus of claim 1, wherein the standard depth data is generated by the following operations:
emitting second light to the driver and receiving the second light reflected by the driver to generate second reflected light data, wherein the driver is in a standard driving posture; and
calculating the standard depth data corresponding to the driver based on the second reflected light data.

8. The driver monitoring apparatus of claim 1, wherein the operation of determining whether to execute the warning operation further comprises:
in response to the depth difference being greater than a difference threshold, calculating an abnormal duration; and
in response to the abnormal duration exceeding a duration threshold, executing the warning operation.

9. The driver monitoring apparatus of claim 1, wherein the warning operation comprises:
adjusting a driving assistance parameter to increase a level of driving assistance involvement for a vehicle drove by the driver.

10. The driver monitoring apparatus of claim 1, wherein the warning operation comprises:
generating a control signal to make an output apparatus to issue warning.

11. A driver monitoring method, being adapted for use in an electronic apparatus, wherein the driver monitoring method comprises the following steps:
emitting first light toward a driver;
receiving the first light reflected by the driver to generate first reflected light data;
calculating real-time depth data of the driver based on the first reflected light data;
comparing the real-time depth data and standard depth data to calculate a depth difference; and
determining whether to execute a warning operation based on the depth difference.

12. The driver monitoring method of claim 11, wherein the step of calculating the real-time depth data further comprises:
transforming the first reflected light data to a plurality of first three-dimensional coordinates by using a time-of-flight calculation; and
taking the first three-dimensional coordinates as the real-time depth data.

13. The driver monitoring method of claim 12, wherein the step of transforming the first reflected light data to the first three-dimensional coordinates further comprises:
calculating the first three-dimensional coordinates based on a plurality of reflecting distances, a plurality of first reflecting angles, and a plurality of second reflecting angles.

14. The driver monitoring method of claim 11, wherein the step of calculating the depth difference further comprises:
matching the standard depth data to the real-time depth data based on a plurality of first three-dimensional coordinates of the real-time depth data; and
calculating a difference between the real-time depth data and the matched standard depth data as the depth difference.

15. The driver monitoring method of claim 11, wherein the step of calculating the depth difference further comprises a plurality of iterative operations, wherein each of the iterative operations comprises the following steps:
selecting one of a plurality of first three-dimensional coordinates of the real-time depth data as a corresponding point based on each of a plurality of second three-dimensional coordinates of the standard depth data;
calculating a transformation matrix based on the second three-dimensional coordinates and the corresponding point corresponding to each of the second three-dimensional coordinates;
transforming the second three-dimensional coordinates based on the transformation matrix; and
calculating a root-mean-square error based on the transformed second three-dimensional coordinates and the first three-dimensional coordinates.

16. The driver monitoring method of claim 15, wherein the step of calculating the depth difference further comprises:
in response to performing the iterative operations reaching a times threshold, taking the root-mean-square error calculated in the last iterative operation as the depth difference.

17. The driver monitoring method of claim 11, wherein the standard depth data is generated by the following steps:
emitting second light to the driver and receiving the second light reflected by the driver to generate second reflected light data, wherein the driver is in a standard driving posture; and
calculating the standard depth data corresponding to the driver based on the second reflected light data.

18. The driver monitoring method of claim 11, wherein the step of determining whether to execute the warning operation further comprises:
in response to the depth difference being greater than a difference threshold, calculating an abnormal duration; and
in response to the abnormal duration exceeding a duration threshold, executing the warning operation.

19. The driver monitoring method of claim 11, wherein the warning operation comprises:
adjusting a driving assistance parameter to increase a level of driving assistance involvement for a vehicle drove by the driver.

20. The driver monitoring method of claim 11, wherein the warning operation comprises:
generating a control signal to make an output apparatus to issue warning.
